(19) United States
(12) Patent Application Publication
(10) Pub. No.: US 2026/0190062 A1
(43) Pub. Date: Jul. 2, 2026

(54) APPARATUS, METHOD, AND COMPUTER PROGRAM

(71) Applicant: Nokia Technologies Oy, Espoo (FI)

(72) Inventors: Alessio CASATI, WEST MOLESEY (GB); Maria OIKONOMAKOU, Massy (FR); Daniela LASELVA, Aalborg (DK); Mads LAURIDSEN, Aalborg (DK)

(21) Appl. No.: 19/130,595

(22) PCT Filed: Jan. 2, 2024
(86) PCT No.: PCT/EP2024/050022

§ 371 Date: May 16, 2025

(30) Foreign Application Priority Data
Dec. 30, 2022 (GB) 2219850.1

(51) Int. Cl. H04W 60/00; H04W 24/04; H04W 36/16; H04W 48/18

(52) U.S. Cl. CPC H04W 60/001; H04W 24/04; H04W 36/165; H04W 48/18

(57) ABSTRACT

There is provided a method, apparatus and computer program for causing a user equipment to perform: receiving, from at least one of a first network operator and a second network operator, first signalling comprising an indication that at least one first cell provided by the first network operator is or will be shutdown for a predetermined event, the first signalling comprising a first identifier that identifies the predetermined event; and selecting the second network operator for receiving services via the second network operator based on the first signalling.

### FIELD OF THE DISCLOSURE

The examples described herein generally relate to apparatus, methods, and computer programs, and more particularly (but not exclusively) to apparatus, methods and computer programs for apparatus.

### BACKGROUND

A communication system can be seen as a facility that enables communication sessions between two or more entities, such as communication devices, base stations and/or other nodes by providing carriers between the various entities involved in the communications path.

The communication system may be a wireless communication system. Examples of wireless systems comprise public land mobile networks (PLMN) operating based on radio standards, such as those provided by the 3rd Generation Partnership Project (3GPP), satellite-based communication systems and different wireless local networks, for example wireless local area networks (WLAN). The wireless systems can be divided into cells, and are therefore referred to as cellular systems.

The communication system and associated devices may operate in accordance with a given standard or specification which sets out what the various entities associated with the system are permitted to do and how that should be achieved. Communication protocols and/or parameters to be used for the connection may be defined according to standard. Examples of such standards are the so-called 5G standards. 3GPP has issued a number of releases (Rel) for defining operating communication protocols related to a communications network.

### SUMMARY

According to a first aspect, there is provided a method for a user equipment, the method comprising: receiving, from at least one of a first network operator and a second network operator, first signalling comprising an indication that at least one first cell provided by the first network operator is or will be shutdown for a predetermined event, the first signalling comprising a first identifier that identifies the predetermined event; and selecting the second network operator for receiving services via the second network operator based on the first signalling.

The selecting may further comprise: attempting to register with the second network operator for receiving said services via the second network operator by: signalling a first registration request to the second network operator, the first registration request comprising the first identifier; and receiving, from the second network operator, a response to the registration request.

When the attempting to register is not performed successfully, the method may further comprise receiving, from the second network operator, an indication that the registration attempt has been unsuccessful.

When the attempting to register is performed successfully, the method may further comprise receiving said services from the second network operator.

The method may comprise: receiving, from at least one of the first and second network operators, an indication of when the predetermined event will end; and based on an end of the predetermined event, deregistering with the second network operator for said services and registering with the first network operator for said services.

Said deregistering may be performed by signalling a deregistration request to the second network operator, the deregistration request comprising the first identifier.

Said deregistering may be performed by receiving, from the second network operator, an indication that the user equipment has been deregistered by the second network operator for receiving said services in the second network.

The method may comprise: abstaining from searching for the first network operator until at least the end of the predetermined event.

The method may comprise: receiving, in the first signalling, an indication of a first time period during which the user equipment is to attempt to register with the second network operator; and causing the attempt to register with the second network operator to be performed within said first time period.

The method may comprise, prior to said selecting, receiving said services from the first network operator.

The method may comprise, prior to receiving said first signalling: signalling, to the first network operator, an indication that the user equipment supports registering with the second network operator for receiving said services based on the first network operator performing predetermined shutdowns of at least one cell operated by the first network operator.

The method may comprise: receiving, from at least one of the first and second network operators, an indication of at least one second preferred frequency band for discovering the first network operator after the predetermined event ends; and based on an end of the predetermined event, discovering and attempting to register with the first network operator for said services using the at least one second preferred frequency band.

The method may comprise: receiving, in the first signalling, at least one first preferred frequency band and/or an identifier of the second network operator for selecting the second network operator; and using the identifier of the second network operator and/or the at least one first preferred frequency band for selecting the second network operator.

The identifier of the second network operator may be at least one of: a physical call identifier; a new radio cell global identifier; a tracking area identifier; or a public land mobile network identifier.

The selecting a second network operator may comprise selecting at least one cell of the second network operator.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a second aspect, there is provided a method for a first network function operated by a first network operator, the method comprising: causing a user equipment to be registered for services via the first network operator based on receiving a first registration request from the user equipment, the first registration request comprising an indication that the user equipment supports registering with a second network operator for receiving said services after the first network operator performs predetermined shutdowns of at least one cell operated by the first network operator, the second network operator providing at least one second cell that at least partially overlaps with the at least one first cell; causing said services to be provided to the user equipment; determining that at least one first cell provided by the first network operator that provides said services to the user equipment will be shutdown for a predetermined event; causing the user equipment to be signalled with first signalling comprising an indication that the least one first cell will be shutdown for a predetermined event, the first signalling further comprising a first identifier that identifies the predetermined event; and causing said at least one first cell to be shutdown.

The method may comprise: causing an indication of when the predetermined event will end to be signalled to the user equipment.

The method may comprise: causing at least one first preferred frequency band and/or an identifier of the second network operator for discovering the second network operator to be provided in the first signalling.

The identifier of the second network operator may be at least one of: a physical call identifier; a new radio cell global identifier; a tracking area identifier; or a public land mobile network identifier.

The method may comprise: causing an indication of a first time period during which the user equipment is to attempt to register with the second network operator to be provided in the first signalling.

The method may comprise: causing an indication of at least one second preferred frequency band, for discovering the first network operator after the predetermined event ends, to be provided to the user equipment.

The method may comprise, prior to causing the user equipment to be registered for said services: forming, with the second network operator, an agreement defining when the second network operator is to provide said services to user equipment registered with the first network operator based on predetermined shutdowns of at least one cell operated by the first network operator, wherein the agreement defines when and where the predetermined shutdowns are to occur and defines how identifiers for those predetermined events are determined.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a third aspect, there is provided a method for a second network function operated by a second network operator, the method comprising: determining whether to cause a user equipment to be registered with the second network operator based on receiving signalling comprising a first registration request from the user equipment, the first registration request comprising a first identifier, the first identifier identifying a predetermined event in which at least one first cell provided by a first network operator is shutdown for the duration of a predetermined event; and signalling a result of said determining to the user equipment.

The method may comprise causing services to be provided to the user equipment during the predetermined event.

The method may comprise: causing an indication of when the predetermined event will end to be signalled to the user equipment; and causing the user equipment to be deregistered from the second network operator after the predetermined event ends.

Said deregistering may be performed based on receiving, from the user equipment, a deregistration request to the second network operator, the deregistration request comprising the first identifier.

Said deregistering may be performed by deregistering the user equipment from the second network operator for receiving services via the second network operator.

The method may comprise causing an indication of at least one second preferred frequency band for discovering the first network operator after the predetermined event ends to be provided to the user equipment.

The method may comprise: determining not to cause the user equipment to be registered with the second network operator receiving signalling from the user equipment; and signalling, to the user equipment, an indication that the user equipment will not be registered with the second network operator for receiving services.

The method may comprise, prior to determining whether to cause the user equipment with the second network operator: forming, with the first network operator, an agreement defining when the second network operator is to provide services to user equipment registered with the first network operator based on predetermined shutdowns of at least one cell operated by the first network operator, wherein the agreement defines when and where the predetermined shutdowns are to occur and defines how identifiers for those predetermined events are determined.

The method may comprise, prior to said determining whether to cause the user equipment to be registered with the second network operator, signalling first signalling that comprises the first identifier.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a fourth aspect, there is provided an apparatus for a user equipment, the apparatus comprising means for: receiving, from at least one of a first network operator and a second network operator, first signalling comprising an indication that at least one first cell provided by the first network operator is or will be shutdown for a predetermined event, the first signalling comprising a first identifier that identifies the predetermined event; and selecting the second network operator for receiving services via the second network operator based on the first signalling.

The means for selecting may further comprise means for: attempting to register with the second network operator for receiving said services via the second network operator by: signalling a first registration request to the second network operator, the first registration request comprising the first identifier; and receiving, from the second network operator, a response to the registration request.

When the attempting to register is not performed successfully, the apparatus may comprise means for receiving, from the second network operator, an indication that the registration attempt has been unsuccessful.

When the attempting to register is performed successfully, the apparatus may comprise means for receiving said services from the second network operator.

The apparatus may comprise means for: receiving, from at least one of the first and second network operators, an indication of when the predetermined event will end; and based on an end of the predetermined event, deregistering with the second network operator for said services and registering with the first network operator for said services.

Said deregistering may be performed by signalling a deregistration request to the second network operator, the deregistration request comprising the first identifier.

Said deregistering may be performed by receiving, from the second network operator, an indication that the user equipment has been deregistered by the second network operator for receiving said services in the second network.

The apparatus may comprise means for: abstaining from searching for the first network operator until at least the end of the predetermined event.

The apparatus may comprise means for: receiving, in the first signalling, an indication of a first time period during which the user equipment is to attempt to register with the second network operator; and causing the attempt to register with the second network operator to be performed within said first time period.

The apparatus may comprise means for, prior to said selecting, receiving said services from the first network operator.

The apparatus may comprise means for, prior to receiving said first signalling: signalling, to the first network operator, an indication that the user equipment supports registering with the second network operator for receiving said services based on the first network operator performing predetermined shutdowns of at least one cell operated by the first network operator.

The apparatus may comprise means for: receiving, from at least one of the first and second network operators, an indication of at least one second preferred frequency band for discovering the first network operator after the predetermined event ends; and based on an end of the predetermined event, discovering and attempting to register with the first network operator for said services using the at least one second preferred frequency band.

The apparatus may comprise means for: receiving, in the first signalling, at least one first preferred frequency band and/or an identifier of the second network operator for selecting the second network operator; and using the identifier of the second network operator and/or the at least one first preferred frequency band for selecting the second network operator.

The identifier of the second network operator may be at least one of: a physical call identifier; a new radio cell global identifier; a tracking area identifier; or a public land mobile network identifier.

The selecting a second network operator may comprise selecting at least one cell of the second network operator.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a fifth aspect, there is provided an apparatus for a first network function operated by a first network operator, the apparatus comprising means for: causing a user equipment to be registered for services via the first network operator based on receiving a first registration request from the user equipment, the first registration request comprising an indication that the user equipment supports registering with a second network operator for receiving said services after the first network operator performs predetermined shutdowns of at least one cell operated by the first network operator, the second network operator providing at least one second cell that at least partially overlaps with the at least one first cell; causing said services to be provided to the user equipment; determining that at least one first cell provided by the first network operator that provides said services to the user equipment will be shutdown for a predetermined event; causing the user equipment to be signalled with first signalling comprising an indication that the least one first cell will be shutdown for a predetermined event, the first signalling further comprising a first identifier that identifies the predetermined event; and causing said at least one first cell to be shutdown.

The apparatus may comprise means for: causing an indication of when the predetermined event will end to be signalled to the user equipment.

The apparatus may comprise means for: causing at least one first preferred frequency band and/or an identifier of the second network operator for discovering the second network operator to be provided in the first signalling.

The identifier of the second network operator may be at least one of: a physical call identifier; a new radio cell global identifier; a tracking area identifier; or a public land mobile network identifier.

The apparatus may comprise means for: causing an indication of a first time period during which the user equipment is to attempt to register with the second network operator to be provided in the first signalling.

The apparatus may comprise means for: causing an indication of at least one second preferred frequency band, for discovering the first network operator after the predetermined event ends, to be provided to the user equipment.

The apparatus may comprise means for, prior to causing the user equipment to be registered for said services: forming, with the second network operator, an agreement defining when the second network operator is to provide said services to user equipment registered with the first network operator based on predetermined shutdowns of at least one cell operated by the first network operator, wherein the agreement defines when and where the predetermined shutdowns are to occur and defines how identifiers for those predetermined events are determined.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a sixth aspect, there is provided an apparatus for a second network function operated by a second network operator, the apparatus comprising means for: determining whether to cause a user equipment to be registered with the second network operator based on receiving signalling comprising a first registration request from the user equipment, the first registration request comprising a first identifier, the first identifier identifying a predetermined event in which at least one first cell provided by a first network operator is shutdown for the duration of a predetermined event; and signalling a result of said determining to the user equipment.

The apparatus may comprise means for causing services to be provided to the user equipment during the predetermined event.

The apparatus may comprise means for: causing an indication of when the predetermined event will end to be signalled to the user equipment; and causing the user equipment to be deregistered from the second network operator after the predetermined event ends.

Said deregistering may be performed based on receiving, from the user equipment, a deregistration request to the second network operator, the deregistration request comprising the first identifier.

Said deregistering may be performed by deregistering the user equipment from the second network operator for receiving services via the second network operator.

The apparatus may comprise means for causing an indication of at least one second preferred frequency band for discovering the first network operator after the predetermined event ends to be provided to the user equipment.

The apparatus may comprise means for: determining not to cause the user equipment to be registered with the second network operator receiving signalling from the user equipment; and signalling, to the user equipment, an indication that the user equipment will not be registered with the second network operator for receiving services.

The apparatus may comprise means for, prior to determining whether to cause the user equipment with the second network operator: forming, with the first network operator, an agreement defining when the second network operator is to provide services to user equipment registered with the first network operator based on predetermined shutdowns of at least one cell operated by the first network operator, wherein the agreement defines when and where the predetermined shutdowns are to occur and defines how identifiers for those predetermined events are determined.

The apparatus may comprise means for, prior to said determining whether to cause the user equipment to be registered with the second network operator, signalling first signalling that comprises the first identifier.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a seventh aspect, there is provided an apparatus for a user equipment, the apparatus comprising: at least one processor; and at least one memory comprising code that, when executed by the at least one processor, causes the apparatus to perform: receiving, from at least one of a first network operator and a second network operator, first signalling comprising an indication that at least one first cell provided by the first network operator is or will be shutdown for a predetermined event, the first signalling comprising a first identifier that identifies the predetermined event; and selecting the second network operator for receiving services via the second network operator based on the first signalling.

The selecting may further comprise: attempting to register with the second network operator for receiving said services via the second network operator by: signalling a first registration request to the second network operator, the first registration request comprising the first identifier; and receiving, from the second network operator, a response to the registration request.

When the attempting to register is not performed successfully, the apparatus may be caused to perform receiving, from the second network operator, an indication that the registration attempt has been unsuccessful.

When the attempting to register is performed successfully, the apparatus may be caused to perform receiving said services from the second network operator.

The apparatus may be caused to perform: receiving, from at least one of the first and second network operators, an indication of when the predetermined event will end; and based on an end of the predetermined event, deregistering with the second network operator for said services and registering with the first network operator for said services.

Said deregistering may be performed by signalling a deregistration request to the second network operator, the deregistration request comprising the first identifier.

Said deregistering may be performed by receiving, from the second network operator, an indication that the user equipment has been deregistered by the second network operator for receiving said services in the second network.

The apparatus may be caused to perform: abstaining from searching for the first network operator until at least the end of the predetermined event.

The apparatus may be caused to perform for: receiving, in the first signalling, an indication of a first time period during which the user equipment is to attempt to register with the second network operator; and causing the attempt to register with the second network operator to be performed within said first time period.

The apparatus may be caused to perform, prior to said selecting, receiving said services from the first network operator.

The apparatus may be caused to perform, prior to receiving said first signalling: signalling, to the first network operator, an indication that the user equipment supports registering with the second network operator for receiving said services based on the first network operator performing predetermined shutdowns of at least one cell operated by the first network operator.

The apparatus may be caused to perform: receiving, from at least one of the first and second network operators, an indication of at least one second preferred frequency band for discovering the first network operator after the predetermined event ends; and based on an end of the predetermined event, discovering and attempting to register with the first network operator for said services using the at least one second preferred frequency band.

The apparatus may be caused to perform: receiving, in the first signalling, at least one first preferred frequency band and/or an identifier of the second network operator for selecting the second network operator; and using the identifier of the second network operator and/or the at least one first preferred frequency band for selecting the second network operator.

The identifier of the second network operator may be at least one of: a physical call identifier; a new radio cell global identifier; a tracking area identifier; or a public land mobile network identifier.

The selecting a second network operator may comprise selecting at least one cell of the second network operator.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to an eighth aspect, there is provided an apparatus for a first network function operated by a first network operator, the apparatus comprising: at least one processor; and at least one memory comprising code that, when executed by the at least one processor, causes the apparatus to perform: causing a user equipment to be registered for services via the first network operator based on receiving a first registration request from the user equipment, the first registration request comprising an indication that the user equipment supports registering with a second network operator for receiving said services after the first network operator performs predetermined shutdowns of at least one cell operated by the first network operator, the second network operator providing at least one second cell that at least partially overlaps with the at least one first cell; causing said services to be provided to the user equipment; determining that at least one first cell provided by the first network operator that provides said services to the user equipment will be shutdown for a predetermined event; causing the user equipment to be signalled with first signalling comprising an indication that the least one first cell will be shutdown for a predetermined event, the first signalling further comprising a first identifier that identifies the predetermined event; and causing said at least one first cell to be shutdown.

The apparatus may be caused to perform: causing an indication of when the predetermined event will end to be signalled to the user equipment.

The apparatus may be caused to perform: causing at least one first preferred frequency band and/or an identifier of the second network operator for discovering the second network operator to be provided in the first signalling.

The identifier of the second network operator may be at least one of: a physical call identifier; a new radio cell global identifier; a tracking area identifier; or a public land mobile network identifier.

The apparatus may be caused to perform: causing an indication of a first time period during which the user equipment is to attempt to register with the second network operator to be provided in the first signalling.

The apparatus may be caused to perform: causing an indication of at least one second preferred frequency band, for discovering the first network operator after the predetermined event ends, to be provided to the user equipment.

The apparatus may be caused to perform, prior to causing the user equipment to be registered for said services: forming, with the second network operator, an agreement defining when the second network operator is to provide said services to user equipment registered with the first network operator based on predetermined shutdowns of at least one cell operated by the first network operator, wherein the agreement defines when and where the predetermined shutdowns are to occur and defines how identifiers for those predetermined events are determined.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a ninth aspect, there is provided an apparatus for a second network function operated by a second network operator, the apparatus comprising: at least one processor; and at least one memory comprising code that, when executed by the at least one processor, causes the apparatus to perform: determining whether to cause a user equipment to be registered with the second network operator based on receiving signalling comprising a first registration request from the user equipment, the first registration request comprising a first identifier, the first identifier identifying a predetermined event in which at least one first cell provided by a first network operator is shutdown for the duration of a predetermined event; and signalling a result of said determining to the user equipment.

The apparatus may be caused to perform causing services to be provided to the user equipment during the predetermined event.

The apparatus may be caused to perform: causing an indication of when the predetermined event will end to be signalled to the user equipment; and causing the user equipment to be deregistered from the second network operator after the predetermined event ends.

Said deregistering may be performed based on receiving, from the user equipment, a deregistration request to the second network operator, the deregistration request comprising the first identifier.

Said deregistering may be performed by deregistering the user equipment from the second network operator for receiving services via the second network operator.

The apparatus may be caused to perform causing an indication of at least one second preferred frequency band for discovering the first network operator after the predetermined event ends to be provided to the user equipment.

The apparatus may be caused to perform: determining not to cause the user equipment to be registered with the second network operator receiving signalling from the user equipment; and signalling, to the user equipment, an indication that the user equipment will not be registered with the second network operator for receiving services.

The apparatus may be caused to perform, prior to determining whether to cause the user equipment with the second network operator: forming, with the first network operator, an agreement defining when the second network operator is to provide services to user equipment registered with the first network operator based on predetermined shutdowns of at least one cell operated by the first network operator, wherein the agreement defines when and where the predetermined shutdowns are to occur and defines how identifiers for those predetermined events are determined.

The apparatus may be caused to perform, prior to said determining whether to cause the user equipment to be registered with the second network operator, signalling first signalling that comprises the first identifier.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a tenth aspect, there is provided an apparatus for a user equipment, the apparatus comprising: receiving circuitry for receiving, from at least one of a first network operator and a second network operator, first signalling comprising an indication that at least one first cell provided by the first network operator is or will be shutdown for a predetermined event, the first signalling comprising a first identifier that identifies the predetermined event; and selecting circuitry for selecting the second network operator for receiving services via the second network operator based on the first signalling.

The means for selecting may further comprise: registering circuitry for attempting to register with the second network operator for receiving said services via the second network operator by: signalling a first registration request to the second network operator, the first registration request comprising the first identifier; and receiving, from the second network operator, a response to the registration request.

When the attempting to register is not performed successfully, the apparatus may comprise receiving circuitry for receiving, from the second network operator, an indication that the registration attempt has been unsuccessful.

When the attempting to register is performed successfully, the apparatus may comprise receiving circuitry for receiving said services from the second network operator.

The apparatus may comprise: receiving circuitry for receiving, from at least one of the first and second network operators, an indication of when the predetermined event will end; and deregistering circuitry for, based on an end of the predetermined event, deregistering with the second network operator for said services and registering with the first network operator for said services.

Said deregistering circuitry for deregistering may comprise signalling circuitry for signalling a deregistration request to the second network operator, the deregistration request comprising the first identifier.

Said deregistering circuitry may comprise receiving circuitry for receiving, from the second network operator, an indication that the user equipment has been deregistered by the second network operator for receiving said services in the second network.

The apparatus may comprise: abstaining circuitry for abstaining from searching for the first network operator until at least the end of the predetermined event.

The apparatus may comprise: receiving circuitry for receiving, in the first signalling, an indication of a first time period during which the user equipment is to attempt to register with the second network operator; and causing the attempt to register with the second network operator to be performed within said first time period.

The apparatus may comprise receiving circuitry for, prior to said selecting, receiving said services from the first network operator.

The apparatus may comprise, prior to receiving said first signalling: signalling circuitry for signalling, to the first network operator, an indication that the user equipment supports registering with the second network operator for receiving said services based on the first network operator performing predetermined shutdowns of at least one cell operated by the first network operator.

The apparatus may comprise: receiving circuitry for receiving, from at least one of the first and second network operators, an indication of at least one second preferred frequency band for discovering the first network operator after the predetermined event ends; and discovering circuitry for, based on an end of the predetermined event, discovering and attempting to register with the first network operator for said services using the at least one second preferred frequency band.

The apparatus may comprise: receiving circuitry for receiving, in the first signalling, at least one first preferred frequency band and/or an identifier of the second network operator for selecting the second network operator; and using the identifier of the second network operator and/or the at least one first preferred frequency band for selecting the second network operator.

The identifier of the second network operator may be at least one of: a physical call identifier; a new radio cell global identifier; a tracking area identifier;

or a public land mobile network identifier.

The selecting a second network operator may comprise selecting at least one cell of the second network operator.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to an eleventh aspect, there is provided an apparatus for a first network function operated by a first network operator, the apparatus comprising: causing circuitry for causing a user equipment to be registered for services via the first network operator based on receiving a first registration request from the user equipment, the first registration request comprising an indication that the user equipment supports registering with a second network operator for receiving said services after the first network operator performs predetermined shutdowns of at least one cell operated by the first network operator, the second network operator providing at least one second cell that at least partially overlaps with the at least one first cell; causing circuitry for causing said services to be provided to the user equipment; determining circuitry for determining that at least one first cell provided by the first network operator that provides said services to the user equipment will be shutdown for a predetermined event; causing circuitry for causing the user equipment to be signalled with first signalling comprising an indication that the least one first cell will be shutdown for a predetermined event, the first signalling further comprising a first identifier that identifies the predetermined event; and causing circuitry for causing said at least one first cell to be shutdown.

The apparatus may comprise: causing circuitry for causing an indication of when the predetermined event will end to be signalled to the user equipment.

The apparatus may comprise: causing circuitry for causing at least one first preferred frequency band and/or an identifier of the second network operator for discovering the second network operator to be provided in the first signalling.

The identifier of the second network operator may be at least one of: a physical call identifier; a new radio cell global identifier; a tracking area identifier; or a public land mobile network identifier.

The apparatus may comprise: causing circuitry for causing an indication of a first time period during which the user equipment is to attempt to register with the second network operator to be provided in the first signalling.

The apparatus may comprise: causing circuitry for causing an indication of at least one second preferred frequency band, for discovering the first network operator after the predetermined event ends, to be provided to the user equipment.

The apparatus may comprise, prior to causing the user equipment to be registered for said services: forming circuitry for forming, with the second network operator, an agreement defining when the second network operator is to provide said services to user equipment registered with the first network operator based on predetermined shutdowns of at least one cell operated by the first network operator, wherein the agreement defines when and where the predetermined shutdowns are to occur and defines how identifiers for those predetermined events are determined.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a twelfth aspect, there is provided an apparatus for a second network function operated by a second network operator, the apparatus comprising: determining circuitry for determining whether to cause a user equipment to be registered with the second network operator based on receiving signalling comprising a first registration request from the user equipment, the first registration request comprising a first identifier, the first identifier identifying a predetermined event in which at least one first cell provided by a first network operator is shutdown for the duration of a predetermined event; and signalling circuitry for signalling a result of said determining to the user equipment.

The apparatus may comprise causing circuitry for causing services to be provided to the user equipment during the predetermined event.

The apparatus may comprise: causing circuitry for causing an indication of when the predetermined event will end to be signalled to the user equipment; and causing circuitry for causing the user equipment to be deregistered from the second network operator after the predetermined event ends.

Said deregistering may be performed based on receiving, from the user equipment, a deregistration request to the second network operator, the deregistration request comprising the first identifier.

Said deregistering may be performed by deregistering the user equipment from the second network operator for receiving services via the second network operator.

The apparatus may comprise causing circuitry for causing an indication of at least one second preferred frequency band for discovering the first network operator after the predetermined event ends to be provided to the user equipment.

The apparatus may comprise: determining circuitry for determining not to cause the user equipment to be registered with the second network operator receiving signalling from the user equipment; and signalling circuitry for signalling, to the user equipment, an indication that the user equipment will not be registered with the second network operator for receiving services.

The apparatus may comprise, prior to determining whether to cause the user equipment with the second network operator: forming circuitry for forming, with the first network operator, an agreement defining when the second network operator is to provide services to user equipment registered with the first network operator based on predetermined shutdowns of at least one cell operated by the first network operator, wherein the agreement defines when and where the predetermined shutdowns are to occur and defines how identifiers for those predetermined events are determined.

The apparatus may comprise, prior to said determining whether to cause the user equipment to be registered with the second network operator, signalling circuitry for signalling first signalling that comprises the first identifier. The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a thirteenth aspect, there is provided non-transitory computer readable medium comprising program instructions for causing a user equipment to perform: receiving, from at least one of a first network operator and a second network operator, first signalling comprising an indication that at least one first cell provided by the first network operator is or will be shutdown for a predetermined event, the first signalling comprising a first identifier that identifies the predetermined event; and selecting the second network operator for receiving services via the second network operator based on the first signalling.

The selecting may further comprise: attempting to register with the second network operator for receiving said services via the second network operator by: signalling a first registration request to the second network operator, the first registration request comprising the first identifier; and receiving, from the second network operator, a response to the registration request.

When the attempting to register is not performed successfully, the apparatus may be caused to perform receiving, from the second network operator, an indication that the registration attempt has been unsuccessful.

When the attempting to register is performed successfully, the apparatus may be caused to perform receiving said services from the second network operator.

The apparatus may be caused to perform: receiving, from at least one of the first and second network operators, an indication of when the predetermined event will end; and based on an end of the predetermined event, deregistering with the second network operator for said services and registering with the first network operator for said services.

Said deregistering may be performed by signalling a deregistration request to the second network operator, the deregistration request comprising the first identifier.

Said deregistering may be performed by receiving, from the second network operator, an indication that the user equipment has been deregistered by the second network operator for receiving said services in the second network.

The apparatus may be caused to perform: abstaining from searching for the first network operator until at least the end of the predetermined event.

The apparatus may be caused to perform for: receiving, in the first signalling, an indication of a first time period during which the user equipment is to attempt to register with the second network operator; and causing the attempt to register with the second network operator to be performed within said first time period.

The apparatus may be caused to perform, prior to said selecting, receiving said services from the first network operator.

The apparatus may be caused to perform, prior to receiving said first signalling: signalling, to the first network operator, an indication that the user equipment supports registering with the second network operator for receiving said services based on the first network operator performing predetermined shutdowns of at least one cell operated by the first network operator.

The apparatus may be caused to perform: receiving, from at least one of the first and second network operators, an indication of at least one second preferred frequency band for discovering the first network operator after the predetermined event ends; and based on an end of the predetermined event, discovering and attempting to register with the first network operator for said services using the at least one second preferred frequency band.

The apparatus may be caused to perform: receiving, in the first signalling, at least one first preferred frequency band and/or an identifier of the second network operator for selecting the second network operator; and using the identifier of the second network operator and/or the at least one first preferred frequency band for selecting the second network operator.

The identifier of the second network operator may be at least one of: a physical call identifier; a new radio cell global identifier; a tracking area identifier; or a public land mobile network identifier.

The selecting a second network operator may comprise selecting at least one cell of the second network operator.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a fourteenth aspect, there is provided non-transitory computer readable medium comprising program instructions for causing a first network function operated by a first network operator to perform: causing a user equipment to be registered for services via the first network operator based on receiving a first registration request from the user equipment, the first registration request comprising an indication that the user equipment supports registering with a second network operator for receiving said services after the first network operator performs predetermined shutdowns of at least one cell operated by the first network operator, the second network operator providing at least one second cell that at least partially overlaps with the at least one first cell; causing said services to be provided to the user equipment; determining that at least one first cell provided by the first network operator that provides said services to the user equipment will be shutdown for a predetermined event; causing the user equipment to be signalled with first signalling comprising an indication that the least one first cell will be shutdown for a predetermined event, the first signalling further comprising a first identifier that identifies the predetermined event; and causing said at least one first cell to be shutdown.

The apparatus may be caused to perform: causing an indication of when the predetermined event will end to be signalled to the user equipment.

The apparatus may be caused to perform: causing at least one first preferred frequency band and/or an identifier of the second network operator for discovering the second network operator to be provided in the first signalling.

The identifier of the second network operator may be at least one of: a physical call identifier; a new radio cell global identifier; a tracking area identifier; or a public land mobile network identifier.

The apparatus may be caused to perform: causing an indication of a first time period during which the user equipment is to attempt to register with the second network operator to be provided in the first signalling.

The apparatus may be caused to perform: causing an indication of at least one second preferred frequency band, for discovering the first network operator after the predetermined event ends, to be provided to the user equipment.

The apparatus may be caused to perform, prior to causing the user equipment to be registered for said services: forming, with the second network operator, an agreement defining when the second network operator is to provide said services to user equipment registered with the first network operator based on predetermined shutdowns of at least one cell operated by the first network operator, wherein the agreement defines when and where the predetermined shutdowns are to occur and defines how identifiers for those predetermined events are determined.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a fifteenth aspect, there is provided non-transitory computer readable medium comprising program instructions for causing a second network function operated by a second network operator to perform: determining whether to cause a user equipment to be registered with the second network operator based on receiving signalling comprising a first registration request from the user equipment, the first registration request comprising a first identifier, the first identifier identifying a predetermined event in which at least one first cell provided by a first network operator is shutdown for the duration of a predetermined event; and signalling a result of said determining to the user equipment.

The apparatus may be caused to perform causing services to be provided to the user equipment during the predetermined event.

The apparatus may be caused to perform: causing an indication of when the predetermined event will end to be signalled to the user equipment; and causing the user equipment to be deregistered from the second network operator after the predetermined event ends.

Said deregistering may be performed based on receiving, from the user equipment, a deregistration request to the second network operator, the deregistration request comprising the first identifier.

Said deregistering may be performed by deregistering the user equipment from the second network operator for receiving services via the second network operator.

The apparatus may be caused to perform causing an indication of at least one second preferred frequency band for discovering the first network operator after the predetermined event ends to be provided to the user equipment.

The apparatus may be caused to perform: determining not to cause the user equipment to be registered with the second network operator receiving signalling from the user equipment; and signalling, to the user equipment, an indication that the user equipment will not be registered with the second network operator for receiving services.

The apparatus may be caused to perform, prior to determining whether to cause the user equipment with the second network operator: forming, with the first network operator, an agreement defining when the second network operator is to provide services to user equipment registered with the first network operator based on predetermined shutdowns of at least one cell operated by the first network operator, wherein the agreement defines when and where the predetermined shutdowns are to occur and defines how identifiers for those predetermined events are determined.

The apparatus may be caused to perform, prior to said determining whether to cause the user equipment to be registered with the second network operator, signalling first signalling that comprises the first identifier.

The first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends.

The first network operator may comprise a home public land mobile network of the user equipment, and/or the second network operator may comprise a visited public land mobile network of the user equipment.

The predetermined event may be an energy efficiency event.

According to a sixteenth aspect, there is provided a computer program product stored on a medium that may cause an apparatus to perform any method as described herein.

According to a seventeenth aspect, there is provided an electronic device that may comprise apparatus as described herein.

According to a nineteenth aspect, there is provided a chipset that may comprise an apparatus as described herein.

### BRIEF DESCRIPTION OF FIGS

Some examples, will now be described, merely by way of illustration only, with reference to the accompanying drawings in which:

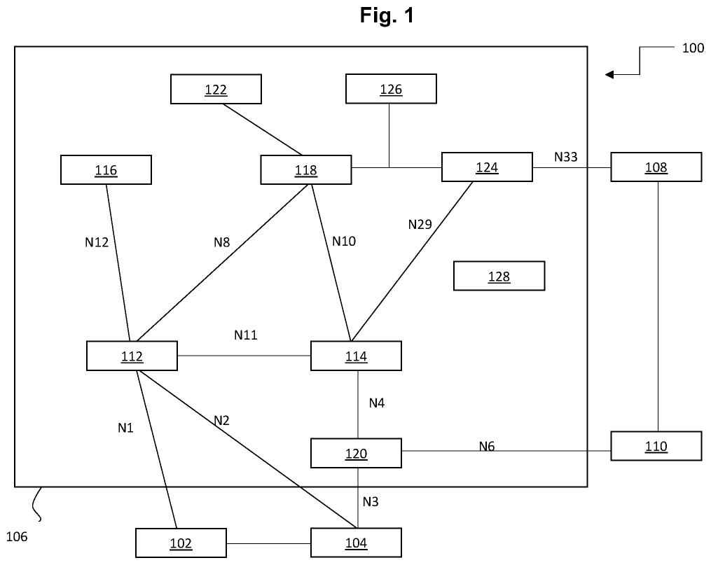

FIG. 1 shows a schematic representation of a 5G system according to at least one example;

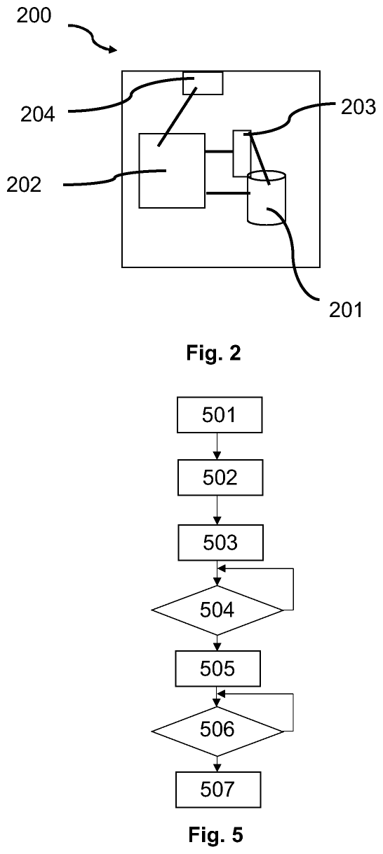

FIG. 2 shows a schematic representation of a network apparatus according to at least one example;

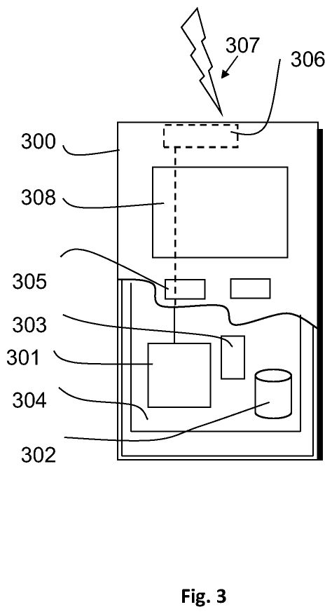

FIG. 3 shows a schematic representation of a user equipment according to at least one example;

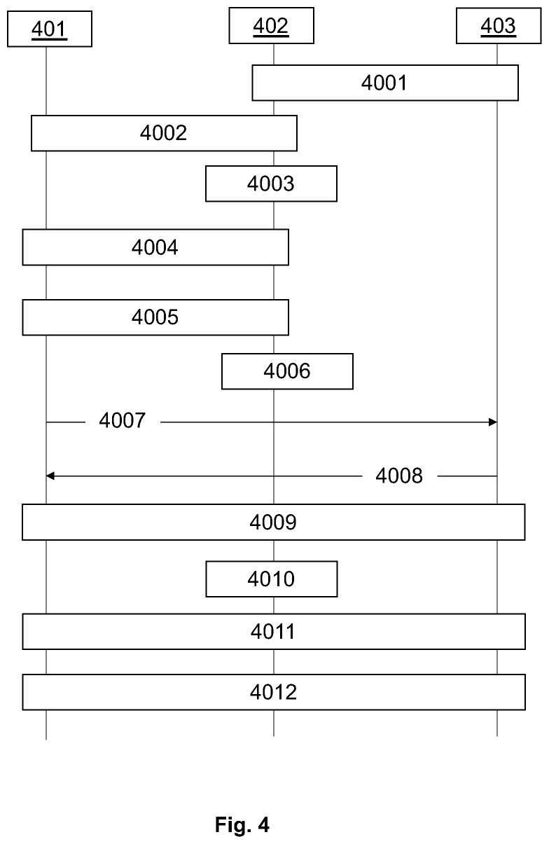

FIG. 4 shows example signalling; and

FIGS. 5 to 9 illustrate example operations that may be performed by apparatus described herein.

### DETAILED DESCRIPTION

In the following description, certain examples are explained with reference to devices that are capable of communication via a wireless cellular system and mobile communication systems serving such mobile communication devices. For brevity and clarity, the following describes such examples with reference to a 5G wireless communication system. However, it is understood that such examples are not limited to 5G wireless communication systems, and may, for example, be applied to other wireless communication systems (e.g., 6G proposals, IEEE 802.11, etc.).

Before describing in detail the examples, certain principles of a 5G wireless communication system are briefly explained with reference to FIGS. 1 to 3.

FIG. 1 shows a schematic representation of a 5G system (5GS) 100 according to at least one example. The 5GS may comprise a user equipment (UE) 102 (which may, for example, also be referred to as a communication device or a terminal), a 5G access network (AN) (which may, for example, be implemented as a 5G Radio Access Network (RAN) or any other type of 5G AN, such as a Non-3GPP Interworking Function (N3IWF), a Trusted Non3GPP Gateway Function (TNGF) for Untrusted or Trusted Non-3GPP access, or Wireline Access Gateway Function (W-AGF) for Wireline access) 104, a 5G core (5GC) 106, one or more application functions (AF) 108 and one or more data networks (DN) 110.

FIG. 2 shows an example of a control apparatus for a communication system. The control apparatus may, for example, be coupled to a station of an access system. Additionally or alternatively, the control apparatus may, for example, be for controlling a station of an access system, such as a RAN node. Example implementations of a station of an access system may include a base station, gNB, a central unit of a cloud architecture, or a node of a core network, such as an MME or S-GW, a scheduling entity, such as a spectrum management entity, or a server or host. Example implementations of a server or host may include an apparatus hosting at least one of an NRF, NWDAF, AMF, SMF, and/or UDM/UDR, and so forth. The control apparatus may, for example, be integrated with a node or module of a core network or RAN. Alternatively, the control apparatus may, for example, be external to a node or module of a core network or RAN. In some examples, base stations comprise a separate control apparatus unit or module. In other examples, the control apparatus can be another network element, such as a radio network controller or a spectrum controller. The control apparatus 200 can be configured to provide control on communications in the service area of the system. The apparatus 200 comprises at least one memory 201, at least one data processing unit 202, 203 and an input/output interface 204. Via the interface, the control apparatus can be coupled to a receiver and a transmitter of the apparatus. The receiver and/or the transmitter may be implemented as a radio front end or a remote radio head. For example, the control apparatus 200 or processor 201 can be configured to execute software code to provide control functions.

An example of a wireless communication device will now be described in more detail with reference to FIG. 3. FIG. 3 shows a schematic, partially sectioned view of a communication device 300 according to at least one example. Such a communication device may, for example, be referred to as user equipment (UE) or terminal. A communication device may be implemented by any device capable of sending and receiving radio signals. Examples of a communication device may, for example, include a mobile station (MS) or mobile device, such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may be configured to provide, for example, communication of data for carrying communications, such as voice, electronic mail (email), text message, multimedia and so on. Users may thus be offered and provided numerous services via their communication devices. Examples of these services may comprise two-way or multi-way calls, data communication or multimedia services or simply an access to a data communication network system, such as the Internet. Users may also be provided broadcast or multicast data. Examples of the content may comprise various types of downloads, television and radio programs, videos, advertisements, various alerts, and other information.

A wireless communication device may, for example, be implemented as a mobile device, or a stationary device. A mobile device may be a device that is not fixed to a particular location. A stationary device may be a device that is fixed to a particular location. The wireless device may, for example, be configured to receive human interaction for communication. Additionally or alternatively, the wireless device may, for example, be configured for communication without human interaction. As described herein, the terms UE or “user” are used to refer to any type of wireless communication device.

The wireless device 300 may be configured to receive signals over an air or radio interface 307 via apparatus for receiving signals (e.g., radio signals). The wireless device 300 may also be configured to transmit signals over the air or radio interface 307 via apparatus for transmitting signals (e.g., radio signals). In FIG. 3, a transceiver apparatus is designated schematically by block 306. The transceiver apparatus 306 may be provided, for example, by means of a radio part and associated antenna arrangement. The antenna arrangement may be arranged internally and/or externally to the wireless device.

A wireless device may comprise at least one data processing entity 301, at least one memory 302 and other possible components 303 for use in software and hardware aided execution of tasks the wireless device is configured to perform. Tasks may, for example, include control of access to and communications with access systems and other communication devices. The data processing, storage and other relevant control apparatus can be provided on an appropriate circuit board and/or in chipsets. This feature is denoted by reference 304. The user may, for example, control the operation of the wireless device by means of a user interface, such as keypad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories (e.g., hands-free equipment) thereto.

Energy saving within communication networks has been defined in a plurality of different 3GPP standards. For example, disaster roaming (roaming for mitigating mobile network outages) is defined in Section 4.4.3.3.1 and Section 3.10 of 3GPP TS 23.122, and relates to the use of a selected number of base transmitter stations (BTSs) when other BTSs are no longer available. In general, roaming may be understood as the use of mobile services from an operator that is not the home operator of the UE consuming the mobile services. One form of roaming, referred to as international roaming, may allow users to use their mobile devices when abroad. National roaming, by way of contrast, may allow users to roaming on networks of multiple operators within the same country. National roaming may, for example, occur in cases where the user cannot reach a base station of his/her home-operator, but instead connects to the base station of another network (roaming).

According to disaster roaming standards, a UE may be configured with a list of Public Land Mobile Network(s) (PLMN(s)) to be used in the event of a “disaster”.

A disaster may, for example, be any event that causes the BTSs of a UE's home network operator to become unable to provide mobile services to the UE. Whether an event is a “disaster event” or not may depend on whether or not a set of conditions (also called “disaster conditions”) are fulfilled.

When a disaster event occurs, the “disaster roaming” service may be activated for the UE upon the UE sending a non-access stratum (NAS) registration request message to an AMF for “disaster roaming”. The registration request may be sent in response to the UE determining that the UE has lost coverage of its' operator's network (e.g., in response to determining that a set of “disaster conditions” has been fulfilled) and upon finding a network that advertises disaster roaming is activated. The network advertising disaster roaming is activated (referred to herein as a “disaster network”) may receive the registration request, which was sent in response to the UE determining that the UE has lost coverage of its operator's network. The AMF controls the UE eligibility to the disaster roaming service and may provide the “disaster roaming” service indication to an Authentication Service Function (AUSF) and UDM. When the set of disaster conditions is determined to no longer be fulfilled, the disaster network causes the UE to perform PLMN re-selection to cause the UE to return to normal operation (e.g., non-disaster operation) to re-register the UE with the UE's operator's network.

The following relates to mechanisms and apparatus for enhancing network energy savings (e.g., 5G networks, 6G networks, and so forth in addition to combinations thereof) during national roaming scenarios. National roaming scenarios are not considered in disaster roaming mechanisms as national roaming scenarios relate to pre-planned shutdowns of BTSs, whereas disaster roaming mechanisms relate to unplanned shutdowns of BTSs.

One strategy for saving energy in national roaming scenarios is to shut down some Radio Access Network (RAN) nodes at times of low usage of those RAN nodes. Eventually only one coverage layer provided by a single RAN node would be available for use by UEs for communicating with the core network. There is a potential for further gain to be exploited by pooling the coverage layer on a regional basis among operators at times of low usage. The following, in some examples, assumes that national roaming is used for energy saving in specific areas and for specific periods of times.

Assuming any regulatory hurdles to national roaming are, for example, removed, an opportunity arises to share the single remaining coverage layer among multiple administrative domains (e.g., amongst multiple PLMNs).

The following mechanisms exploit times when the network coverage for a UE has low network load periods (which may occur, for example, during night-time). During such times, only one of an example two networks may be active in a specific area and can provide coverage to the subscribers of both networks within that specific area, while the other network can apply cell shutdown to obtain network energy savings. Although this and the following examples consider network configurations comprising two operator administrative domains for simplicity, it is understood that analogous techniques may be performed when multiple administrative domains are configured to shut down within a predetermined area and within overlapping time periods, while a single administrative domain provides services to previous users of those multiple administrative domains.

For example, based on roaming agreements and policies, an operator of a first administrative domain (e.g., PLMN1 operator) can agree with an operator of a second administrative domain (e.g., PLMN2 operator) for RAN nodes of the PLMN2 operator to provide access for the PLMN1 subscribers to their network on a per area basis. PLMN1 operator may operate at least one RAN node that provides a coverage area (also referred to herein as “cell”) at least partially overlapping with a coverage area provided by at least one RAN node operated by PLMN2 operator. PLMN1 operator may also provide PLMN2 operator with an indication of why Base Transmitter Stations (BTSs) operated by PLMN1 operator will be shutdown within a specific area. PLMN1 operator may, for example, provide PLMN2 operator with at least a purpose of PLMN1 operator shutting down RAN node(s) that provide a least partial coverage within the specific area. This agreement between the PLMN operators is also referred to herein as an energy efficiency (EE) roaming agreement. PLMN1 is labelled as a “beneficiary PLMN” as it receives energy saving by shutting down at least one RAN node (e.g., at least one BTS). PLMN2 is labelled as a “donor PLMN” as it donates resources towards providing network access to UEs served by the at least one RAN node (e.g., at least one BTS), before it was shutdown.

The beneficiary PLMN (PLMN1) causes the UEs it serves in that area, to register with the donor PLMN (PLMN2) that has agreed to take on the UEs for receiving services via the donor PLMN. The EE national roaming agreement may also comprise a preferred list of bands to enable a faster PLMN selection among the EE national roaming partners, and the preferred list of bands can be indicated to the UE. Time windows over which to remain in EE national roaming and within which certain EE national roaming steps should be completed (e.g., to move to donor PLMN and RETURN to beneficiary PLMN) are also provided to the UE optionally.

To cover for the case of UE(s) of the beneficiary PLMN that attempt to register with the beneficiary PLMN when the beneficiary PLMN has shutdown BTSs that would otherwise have provided service coverage to the UE(s), UE(s) (referred to herein as “supporting UE(s)”) that are capable of supporting EE national roaming processes described herein may be authorized to bypass a “forbidden PLMN LIST” in order to discover donor PLMNs for performing the herein described EE national roaming. A forbidden PLMN list is a list of PLMNs that is maintained on a UE that the UE cannot automatically contact for providing services to the UE. This may be, for example, because the service was declined by a foreign provider.

Donor PLMN cells in the area where the EE national roaming is enabled for the beneficiary PLMN may broadcast that the EE national roaming is enabled for the beneficiary PLMN. This may be signalled via a System Information Block (SIB) transmitted by the donor PLMN.

The broadcast signalling may comprise an identifier for the beneficiary PLMN. The identifier may comprise, for example, at least one of: a beneficiary PLMN ID, and/or an EE national roaming event identifier related to the beneficiary PLMN.

The broadcast signalling may comprise time information indicating when the beneficiary PLMN is expected to provide coverage in the specific area. For example, the signalling may comprise at least one of a scheduled time of end of EE national roaming and/or a grace period for returning to the beneficiary PLMN.

The broadcast signalling may comprise an indication of at least one preferred frequency band of the BTS of the beneficiary PLMN that will be exiting the shutdown state.

The above (and following) described techniques may enable a network controlled and orchestrated EE national roaming procedure to prioritize frequency bands for a specified duration. Such techniques may further enable the identification of the type of EE national roaming event via a respective EE national roaming event identifier associated with the type of EE national roaming event. The EE national roaming event identifier may, for example, identify (e.g., uniquely identify) the EE national roaming event. This EE national roaming event identifier may be used in a variety of ways, such as, to associate UEs to a specific EE national roaming event in the donor network, and/or to cause selective return or registration policies in a donor network (e.g., to deregister all UEs associated to a specific EE national roaming event) and/or to charge the partner network per EE national roaming event (e.g., based on number of UEs per EE national roaming event that are served by the donor PLMN). The EE national roaming event identifier may, in some examples, be a value that is allocated according to policies agreed by the donor and beneficiary PLMN.

FIG. 4 illustrates example signalling that may be performed according to at least one example described herein.

FIG. 4 illustrates signalling that may be performed among a UE 401, a beneficiary RAN node 402 operated by a beneficiary PLMN, and a donor RAN node 403 operated by a donor PLMN.

During 4001, the beneficiary RAN node 402 establishes an EE national roaming agreement. The EE national roaming agreement may, for example, be published by the beneficiary RAN node 402 in such a way that it can be found by potential donor PLMNs. For example, the EE national roaming agreement of beneficiary RAN node 402 may be advertised to international roaming partners of the beneficiary PLMN operating the beneficiary RAN node 402, as the beneficiary RAN node 402 may end up in the Donor PLMN if the beneficiary PLMN is a preferred PLMN for roaming.

The EE national roaming agreement may be considered to be an agreement for network-based energy savings for national roaming, with one of the partner PLMNs of the beneficiary PLMN becoming a donor PLMN for the beneficiary PLMN when at least one network entity of the beneficiary PLMN enters an energy savings mode (e.g., cell and/or BTS shutdown).

The EE national roaming agreement may define a time when the EE national roaming starts and ends, may define an area in which the EE national roaming applies, and may define other parameters, such as preferred frequency band(s) for selection of cells in donor PLMN during donor PLMN selection and beneficiary PLMN upon return. The time may, for example, be an indication that the energy savings may be performed on a daily basis. The area may, for example, define at least one specific area to be covered at the indicated time (e.g., a location and/or reach of the coverage area of the beneficiary RAN node). Other parameters may comprise, for example, a list of frequency band(s) to be used as a default when no other frequency band(s) are agreed. Each of the frequency band(s) in the list may be associated with a respective priority to be used for selecting at least one frequency band from the list.

The EE national roaming agreement may comprise an indication of how to set an EE national roaming event identifier. The EE national roaming event identifier may comprise a value that can change over time. Thus, during 4001, the beneficiary and potential donor PLMNs may also agree on how to set an EE national roaming event identifier to be used during the EE national roaming.

During 4002, the UE 401 performs registration with the beneficiary PLMN. This is illustrated as being performed via the beneficiary RAN node 402, although it is understood that this registration may be performed via any of the RAN nodes operated by the beneficiary PLMN. The registration may be for accessing services provided by the beneficiary PLMN. During this procedure, the UE 401 may signal, to the beneficiary PLMN, an indication that the UE supports the use of one or more EE national roaming techniques described herein.

During 4003, the beneficiary PLMN determines that EE national roaming is to be performed with respect to at least one coverage area (herein referred to as a beneficiary coverage area) provided by the beneficiary RAN node 402. This may be determined by using parameters defined in the EE national roaming agreement of 4001. For example, the EE national roaming agreement may define that beneficiary RAN node 402 is to cause at least one of the coverage areas it operates to no longer provide services to the UE 401 (e.g., to enter a shutdown or low power mode).

During 4004, the beneficiary RAN node 402 signals the UE 401 (in addition to any other UE to which it provides services and that supports the use of EE national roaming techniques) to indicate that the UE 401 should seek to receive one or more services from another administrative domain.

For example, the beneficiary RAN node 402 may transmit, to UE 401 (which is located in the affected coverage area) to perform (e.g., mandatorily perform) PLMN selection to select the donor PLMN of the donor RAN node 403.

The signalling of 4004 may indicate a time period during which, or a time instance at which, the UE 401 is to perform the PLMN selection. For example, the signalling of 4004 may indicate that the UE 401 is to perform the PLMN selection at any time (e.g., random time) within a time window before the EE national roaming start time defined in the EE national roaming agreement.

The signalling of 4004 may comprise an indication of a duration (e.g., “an EE national roaming duration”) during which the UE is expected to be roaming in the donor network.

The signalling of 4004 may comprise an identifier of at least one potential donor PLMN, and/or at least one donor RAN nodes operated by those potential donor PLMNs, and/or at least one coverage area operated by said at least one RAN nodes. For example, the signalling of 4004 may comprise a cell list and/or a tracking area identifier list that identifies at least one coverage area.

The signalling of 4004 may cause the UE 401 to override any information comprised in a list of forbidden PLMNs and/or a list of Preferred PLMNs list in order to cause the UE to be able to select the donor PLMN and the donor RAN node.

The signalling of 4004 may comprise an EE national roaming event identifier to be provided that identifies (e.g., uniquely identifies) the EE national roaming event.

The UE 401 may become deregistered from the beneficiary network. For example, the signalling of 4004 may cause the UE 401 to perform a deregistration with the beneficiary PLMN by signalling a deregistration request to the beneficiary RAN node 402. In such a case, the deregistration performed by the UE 401 may comprise the EE national roaming event identifier. As another mechanism, the beneficiary RAN node 402 may signal a deregistration request to the UE 401 that comprises the EE national roaming event identifier (e.g., using a Deregistration or Registration Reject message).

The signalling of 4004 may comprise, subject to the EE national roaming agreement with the donor PLMN, an indication of a prioritized list of frequency bands of where to look for at least one coverage area provided by the donor PLMN and a prioritized list of frequency bands for when the UE 401 returns to the beneficiary PLMN when the EE national roaming in the donor PLMN ends (e.g., when the EE national roaming duration ends).

The UE 401 may store an identifier of the beneficiary PLMN (e.g., the PLMN ID of the beneficiary PLMN), and any provided frequency band(s) where to search the cell upon return when EE national roaming is scheduled to end.

The signalling of 4004 may be comprised in any of a number of different messages and/or service operations. For example, the signalling of 4004 may be comprised in at least one of a UE CONFIGURATION UPDATE COMMAND service operation, and/or in a REGISTRATION ACCEPT service operation, and/or in a REGISTRATION REJECT service operation, and/or in broadcast from cells or in a DEREGISTRATION REQUEST operation from the network.

During 4005, the UE 401 may perform at least one of a plurality of different actions.

For example, the UE 401 may select the donor RAN node 403 when donor RAN node 403 provides a donor coverage area that at least partially overlaps the beneficiary coverage area provided by the beneficiary RAN node 402.

Further, during 4005, the UE 401 may signal a deregistration request to the beneficiary RAN node 402 for deregistering the UE 401 with the beneficiary PLMN (unless the UE was deregistered with the beneficiary PLMN after receiving a deregistration request from the beneficiary RAN node 402).

Further, during 4005, the UE 401 may identify, from the received signalling of 4004, a time window during which and/or time instance at which to perform a PLMN transition from the beneficiary PLMN to the donor PLMN. Stated differently, the UE 401 may identify, from the received signalling of 4004, when to deregister for services from the beneficiary PLMN and/or when to register for services with the donor PLMN. The registration of UE 401 with the donor PLMN may be performed via the donor RAN node 403. The deregistration of UE 401 with the beneficiary PLMN may be performed via the beneficiary RAN node 402.

The time window may be defined with respect to a common clock to the UE 401 and the beneficiary PLMN and/or beneficiary RAN node 402. The time window may be defined with reference to a time when the UE 401 receives a command from the beneficiary RAN node 402 to initiate a PLMN selection to the donor PLMN. The UE 401 may start the PLMN selection, by initiating a registration procedure in the donor PLMN, at a time (e.g., random time) within this time window. The time window may, in some examples, be limited to a time period before the start of the EE national roaming.

When the time window is signaled inside a non-access stratum (NAS) signaling message, the time window may be defined per UE (e.g., so that each UE 401 receiving a command to perform a PLMN transition to the donor PLMN as part of an EE national roaming mechanism receives a unique time window or receives a same time window as a limited number of other UEs 401, such that not every UE 401 receives the same time window). As an alternative, the time window could be defined at a per cell level of granularity inside affected Tracking Areas.

These types of time windows that limit the number of UEs 401 attempting to register with the donor PLMN at a same time may be useful for staggering and controlling the transition of UEs from the beneficiary PLMN to the donor PLMN in order to prevent congestion in registering the UE 401.

During 4006, the beneficiary PLMN, proceeds to shut down the RAN nodes it operates within the affected area, including beneficiary RAN node 402.

During 4006, although not shown, donor PLMN cells in the area where the EE national roaming is expected, may broadcast information in their respective System Information Blocks (SIBs) about the EE national roaming. The donor PLMN cells may be controlled by at least one donor RAN node that are operated by donor PLMN, such as donor RAN node 403.

The signalling broadcast by the donor PLMN cells may be defined in the above-mentioned EE national roaming agreement. The signalling may comprise an indication that the EE national roaming is enabled for the beneficiary PLMN identified by a beneficiary PLMN identifier, a related EE national roaming ID (mentioned above).

The signalling broadcast by the donor PLMN cells may comprise an end time for ending of the EE national roaming (e.g., a time indicating when the UE 401 should have deregistered from the donor PLMN and have reregistered with the beneficiary PLMN.

The signalling broadcast by the donor PLMN cells may comprise a grace period for the UE 401 to return (e.g., reregister) to the beneficiary PLMN.

The signalling broadcast by the donor PLMN cells may comprise at least one preferred frequency bands of the Beneficiary PLMN for the UE 401 to return (e.g., to reregister) to the beneficiary PLMN.

During 4006, and as mentioned above, the UE 401 (and any other supporting UEs (e.g., a UE capable of supporting EE national roaming mechanisms described herein)) that attempts to register with the beneficiary PLMN when the beneficiary RAN node 402 has been shut down at the location where the UE 401 is, may be authorized to bypass the “forbidden PLMN LIST” and look for any donor PLMNs for EE national roaming. When UE 401 finds the donor RAN node 403, the UE proceeds to 4007.

During 4007, the UE 401 signals the donor RAN node 403. This signalling may comprise a request for the UE 401 to register with the donor RAN.

In this signalling of 4007 (and, for example, in-potentially-all signalling related to mobility procedures during the time EE national roaming according to the EE national roaming agreement is being performed), the UE 401 provides an EE national roaming indication (e.g., an indication that the registration is being performed in response to an EE national roaming event happening) and an identifier associated with the EE national roaming event (e.g., the EE national roaming event identifier value). An AMF located in the donor PLMN may store the identifier associated with the EE national roaming event in the UE context stored for that UE 401 during registration.

When the signalling of 4007 comprises an invalid and/or elapsed identifier associated with the EE national roaming event, the donor RAN node 403 may signal to the UE 401 a registration rejection that indicates the reason for the rejection as “EE national roaming not allowed”.

When the signalling of 4007 comprises a valid identifier associated with the EE national roaming event, the donor RAN node 403 proceeds to 4008.

During 4008, the donor RAN node 403 signals the UE 401. This signalling of 4008 may comprise an indication that the requested registration has been accepted. The signalling of 4008 may also comprise an indication of the duration of the EE national roaming and/or an indication of a grace period for completing the return to the beneficiary PLMN (as mentioned above).

During 4009, the EE national roaming time associated with the EE national roaming agreement elapses.

During 4010, in response to 4009, the beneficiary PLMN causes the previously shutdown area of 4006 to be powered up. For example, the cell(s) and/or tracking areas that were previously shut down during 4006 are restarted.

During 4011, the UE 401 deregisters from the donor PLMN and reregisters with the beneficiary PLMN. As mentioned above, this may be performed using the timing and/or preferred frequency bands provided to the UE 401 during 4008.

During 4012, the donor PLMN may deregister (e.g., implicitly or explicitly) any UEs having the identifier associated with the EE national roaming event stored in their UE context.

Further, during 4012, when the donor PLMN receives any invalid and/or elapsed identifier(s) associated with the EE national roaming event, the donor RAN node 403 may signal to the UE 401 a registration rejection that indicates the reason for the rejection as “EE national roaming not allowed”.

FIG. 5 illustrates operations that may be performed by a UE, such as UE 401.

During 501, the UE registers with a beneficiary PLMN. This registration may indicate that the UE supports EE national roaming mechanisms.

During 502, the UE receives signalling comprising an indication that EE national roaming mechanisms are to be activated for an EE national roaming event. This indication may be received from an AMF located in the beneficiary PLMN's domain.

The signalling received by the UE during 502 may comprise an identifier that identifies (e.g., uniquely identifies) this EE national roaming event, such as a Roaming event identifier.

The signalling received by the UE during 502 may comprise a time instance and/or a time window during which the UE is to register with a donor PLMN for receiving services during the EE national roaming event. This may be as described above with reference to FIG. 4.

The signalling received by the UE during 502 may comprise an identifier of at least one potential donor PLMN that may be used by the UE during the EE national roaming event.

The signalling received by the UE during 502 may comprise at least one frequency band preferred by the at least one potential donor for registration signalling.

During 503, the UE performs a PLMN selection of a donor PLMN based on the information received during 502. For example, the UE looks for at least one of the potential donor PLMNs indicated during 502 using the at least one preferred frequency (when provided).

During 504, the UE determines whether a found cell is transmitting the roaming event identifier (e.g., in an SIB of the potential donor RAN node). When the found cell is not transmitting the roaming event identifier, the UE returns to 503 and finds another potential donor PLMN and/or potential donor RAN node. When the found cell is transmitting the roaming event identifier, the UE proceeds to 505.

During 505, the UE deregisters from the beneficiary PLMN and registers with the donor PLMN found during 503. The registration may be performed using the information received during 502.

For example, at the indicated time instance (and/or during the indicated time window), the UE may signal a registration request to a RAN node operated by a donor PLMN at a preferred frequency of the donor PLMN, where the registration request comprises the identifier that identifies (e.g., uniquely identifies) the EE national roaming event (e.g., the roaming event identifier). 503 to 505 may, for example, all be performed during a time window signalled during 502.

During 506, the UE determines whether or not an “EE national roaming time” has expired. As mentioned in the above example of FIG. 4, the UE may be provided with this information via the beneficiary PLMN (e.g., when the EE national roaming event information is signalled to the UE during 502) or via the donor PLMN (e.g., during registration of 505). The UE may determine that the EE national roaming time has expired (e.g., using information previously received from the donor PLMN and/or beneficiary PLMN regarding when the EE national roaming event will end and a timer or clock accessible by the UE). The UE may determine that the EE national roaming time has expired as a result of the donor PLMN signalling a deregistration command to the UE that comprises an indication that the deregistration is a result of the EE national roaming time expiring.

When the EE national roaming time is determined to have not expired, the UE returns to 506.

When the EE national roaming time is determined to have expired, the UE proceeds to 507.

During 507, the UE deregisters from the donor PLMN. The deregistration may be initiated by the UE and comprise the roaming event identifier. The deregistration may be initiated by the donor PLMN signalling a deregistration command to the UE that comprises the roaming event identifier.

During 507, the UE may optionally reregister with the beneficiary PLMN or with some other PLMN. Any registration may be performed in accordance with the governing standards (e.g., in accordance with 3GPP standards).

As an optional addition, the UE may provide the beneficiary PLMN with an indication of the identity of the donor PLMN used by the UE during the EE national roaming event. This identification may be provided during registration or during some other time, and may be useful for determining, by the beneficiary PLMNs, whether to modify existing EE national roaming agreements with its donor PLMNs.

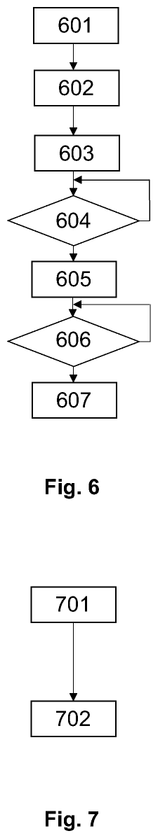

FIG. 6 illustrates operations that may be performed by a UE, such as UE 401. The operations of FIG. 6 differ from those of FIG. 5 in that the operations of FIG. 5 relate to an example in which the UE is currently registered with the beneficiary PLMN for receiving services via the beneficiary PLMN when the EE national roaming event starts, whereas the operations of FIG. 6 relate to an example in which the UE is not currently registered with the beneficiary PLMN for receiving services via the beneficiary PLMN when the EE national roaming event starts. For instance, during the example of FIG. 6, the UE may switch on and/or power on in an area in which the beneficiary PLMN is performing an EE national roaming event. In this example (as, for example, in any other example mentioned herein), the beneficiary PLMN may be considered to be a home PLMN, equivalent home PLMN, or a PLMN allowed for roaming by the home PLMN or equivalent home PLMN.

During 601, the UE determines that the UE supports EE national roaming mechanisms.

During 602, the UE either detects that the UE is located in the UE's home country while the UE cannot detect any Home PLMN or equivalent Home PLMN, or the UE detects that the UE is roaming while the UE cannot detect any PLMN that is allowed for use for roaming by the Home PLMN (e.g., an allowed roaming PLMN).

During 603, the UE enables EE roaming PLMN selection to enable PLMN selection during an EE roaming event.

During 604, the UE determines whether the UE can find a candidate cell that has a roaming event identifier for the Home PLMN, equivalent Home PLMN, or allowed roaming PLMN.

The signalling received by the UE during 604 from at least one candidate cell may comprise an identifier that identifies (e.g., uniquely identifies) this EE national roaming event, such as a Roaming event identifier.

The signalling received by the UE during 604 may comprise a time instance and/or a time window during which the UE is to register with a donor PLMN for receiving services during the EE national roaming event. This may be as described above with reference to FIG. 4.

The signalling received by the UE during 604 may comprise an identifier of at least one potential donor PLMN that may be used by the UE during the EE national roaming event.

The signalling received by the UE during 604 may comprise at least one frequency band preferred by the at least one potential donor for registration signalling.

When the UE cannot find a candidate cell comprising such a Roaming event identifier, the UE repeats 604.

When the UE finds a candidate cell that comprises the Roaming event identifier, the UE proceeds to 605.

During 605, the UE performs a PLMN selection of a donor PLMN based on the information received during 604. For example, the UE looks for at least one of the potential donor PLMNs indicated during 604 using the at least one preferred frequency (when provided).

During 606, the UE determines whether or not an “EE national roaming time” has expired. As mentioned in the above example of FIG. 4, the UE may be provided with this information via the donor PLMN (e.g., during registration of 605 or signalling of 604). The UE may determine that the EE national roaming time has expired autonomously (e.g., using information previously received from the donor PLMN regarding when the EE national roaming event will end and a timer or clock accessible by the UE). The UE may determine that the EE national roaming time has expired as a result of the donor PLMN signalling a deregistration command to the UE that comprises an indication that the deregistration is a result of the EE national roaming time expiring.

When the EE national roaming time is determined to have not expired, the UE returns to 606.

When the EE national roaming time is determined to have expired, the UE proceeds to 607.

During 607, the UE deregisters from the donor PLMN. The deregistration may be initiated by the UE and comprise the roaming event identifier. The deregistration may be initiated by the donor PLMN signalling a deregistration command to the UE that comprises the roaming event identifier.

During 607, the UE may optionally register with the beneficiary PLMN or with some other PLMN. Any registration may be performed in accordance with the governing standards (e.g., in accordance with 3GPP standards).

As an optional addition, the UE may provide the beneficiary PLMN with an indication of the identity of the donor PLMN used by the UE during the EE national roaming event. This identification may be provided during registration or during some other time, and may be useful for determining, by the beneficiary PLMNs, whether to modify existing EE national roaming agreements with its donor PLMNs.

FIGS. 7 to 9 illustrate how features of the above examples may be implemented in specific apparatus. It is therefore understood that features of the above may find correspondence in features described in relation to the below.

FIG. 7 illustrates operations that may be performed by a user equipment (UE).

During 701, the user equipment receives, from at least one of a first network operator and a second network operator, first signalling comprising an indication that at least one first cell provided by the first network operator is or will be shutdown for a predetermined event, the first signalling comprising a first identifier that identifies the predetermined event. The second network operator may operate at least one second cell that at least partially overlaps a coverage area (e.g., an area for providing services to the UE) provided by the at least one first cell.

During 702, the user equipment selects the second network operator for receiving services via the second network operator based on the first signalling (e.g., using information comprised in the first signalling).

The selecting may further comprise the UE: attempting to register with the second network operator for receiving said services via the second network operator by: signalling a first registration request to the second network operator, the first registration request comprising the first identifier; and receiving, from the second network operator, a response to the registration request. The first identifier may uniquely identify the event. The first identifier may identify the type of event. The first identifier may comprise an identifier of at least one of the user equipment or first network operator. The first identifier may comprise a roaming event identifier. The first identifier may comprise an identifier from which the second network operator may determine that the request relates to the predetermined event.

When the attempting to register is not performed successfully, the user equipment may receive, from the second network operator, an indication that the registration attempt has been unsuccessful.

When the attempting to register is performed successfully, the user equipment may receive said services from the second network operator.

The user equipment may receive, from at least one of the first and second network operators, an indication of when the predetermined event will end; and based on an end of the predetermined event, deregistering with the second network operator for said services and registering with the first network operator for said services. For example, the user equipment may perform the deregistering and registering within a predetermined time duration of the end of the predetermined event.

Said deregistering may be performed by signalling a deregistration request to the second network operator, the deregistration request comprising the first identifier.

Said deregistering may be performed by receiving, from the second network operator, an indication that the user equipment has been deregistered by the second network operator for receiving said services in the second network. The first identifier may be comprised in the indication that the user equipment has been deregistered by the second network operator. The first identifier may comprise a roaming event identifier. The user equipment may abstain from searching for the first network operator until at least the end of the predetermined event.

The user equipment may receive, in the first signalling, an indication of a first time period during which the user equipment is to attempt to register with the second network operator; and cause the attempt to register with the second network operator to be performed within said first time period.

The user equipment may, prior to said selecting, receiving said services from the first network operator.

The user equipment may, prior to receiving said first signalling: signal, to the first network operator, an indication that the user equipment supports registering with the second network operator for receiving said services based on (e.g., in response to) the first network operator performing predetermined shutdowns of at least one cell operated by the first network operator.

The user equipment may: receive, from at least one of the first and second network operators, an indication of at least one second preferred frequency band for discovering the first network operator after the predetermined event ends; and based on (e.g., in response to) an end of the predetermined event, discover and attempt to register with the first network operator for said services using the at least one second preferred frequency band.

The user equipment may: receive, in the first signalling, at least one first preferred frequency band and/or an identifier of the second network operator for selecting the second network operator; and use the identifier of the second network operator and/or the at least one first preferred frequency band for selecting the second network operator. The identifier of the second network operator may be at least one of: a physical call identifier; a new radio cell global identifier; a tracking area identifier; or a public land mobile network identifier.

The selecting a second network operator may comprise selecting at least one cell of the second network operator.

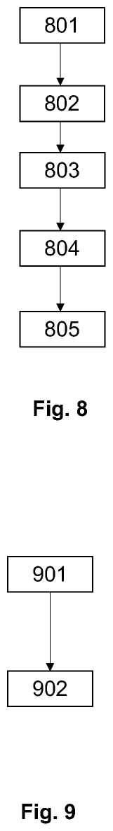

FIG. 8 illustrates operations that may be performed by a first network function operated by a first network operator. The first network function and/or first network operator of FIG. 8 may be the first network function and/or first network operator of FIG. 7. The first network function may comprise a first access and mobility function.

During 801, the first network function causes a user equipment to be registered for services via the first network operator based on receiving a first registration request from the user equipment, the first registration request comprising an indication that the user equipment supports registering with a second network operator for receiving said services after the first network operator performs predetermined shutdowns of at least one cell operated by the first network operator, the second network operator providing at least one second cell that at least partially overlaps with the at least one first cell.

During 802, the first network function causes said services to be provided to the user equipment.

During 803, the first network function determines that at least one first cell provided by the first network operator that provides said services to the user equipment will be shutdown for a predetermined event.

During 804, the first network function causes the user equipment to be signalled with first signalling comprising an indication that the least one first cell will be shutdown for a predetermined event, the first signalling further comprising a first identifier that identifies the predetermined event. The first identifier may uniquely identify the event. The first identifier may identify the type of event. The first identifier may comprise an identifier of at least one of the user equipment or first network operator. The first identifier may comprise a roaming event identifier. The first identifier may comprise an identifier from which the second network operator may determine that the request relates to the predetermined event.

During 805, the first network function causes said at least one first cell to be shutdown.

The first network function may cause an indication of when the predetermined event will end to be signalled to the user equipment.

The first network function may cause at least one first preferred frequency band and/or an identifier of the second network operator for discovering the second network operator to be provided in the first signalling.

The identifier of the second network operator may be at least one of: a physical call identifier; a new radio cell global identifier; a tracking area identifier; or a public land mobile network identifier.

The first network function may cause an indication of a first time period during which the user equipment is to attempt to register with the second network operator to be provided in the first signalling.

The first network function may cause an indication of at least one second preferred frequency band, for discovering the first network operator after the predetermined event ends, to be provided to the user equipment.

The first network function may, prior to causing the user equipment to be registered for said services: form, with the second network operator, an agreement defining when the second network operator is to provide said services to user equipment registered with the first network operator based on predetermined shutdowns of at least one cell operated by the first network operator, wherein the agreement defines when and where the predetermined shutdowns are to occur and defines how identifiers for those predetermined events are determined.

FIG. 9 illustrates operations that may be performed by a second network function operated by a second network operator. The second network function and/or second network operator of FIG. 9 may be the second network function and/or second network operator of FIG. 7 and/or of FIG. 8. The second network function may comprise a second access and mobility function.

During 901, the second network function determines whether to cause a user equipment to be registered with the second network operator based on receiving signalling comprising a first registration request from the user equipment, the first registration request comprising a first identifier, the first identifier identifying a predetermined event in which at least one first cell provided by a first network operator is shutdown for the duration of a predetermined event. The first identifier may uniquely identify the event. The first identifier may identify the type of event. The first identifier may comprise an identifier of at least one of the user equipment or first network operator. The first identifier may comprise a roaming event identifier. The first identifier may comprise an identifier from which the second network operator may determine that the request relates to the predetermined event.

During 902, the second network function signals a result of said determining to the user equipment.

The second network function may cause services to be provided to the user equipment during the predetermined event.

The second network function may: cause an indication of when the predetermined event will end to be signalled to the user equipment; and cause the user equipment to be deregistered from the second network operator after the predetermined event ends.

Said deregistering may be performed based on receiving, from the user equipment, a deregistration request to the second network operator, the deregistration request comprising the first identifier.

Said deregistering may be performed by deregistering the user equipment from the second network operator for receiving services via the second network operator.

The second network function may cause an indication of at least one second preferred frequency band for discovering the first network operator after the predetermined event ends to be provided to the user equipment.

The second network function may: determine not to cause the user equipment to be registered with the second network operator receiving signalling from the user equipment; and signal, to the user equipment, an indication that the user equipment will not be registered with the second network operator for receiving services.

The second network function may, prior to determining whether to cause the user equipment with the second network operator: form, with the first network operator, an agreement defining when the second network operator is to provide services to user equipment registered with the first network operator based on predetermined shutdowns of at least one cell operated by the first network operator, wherein the agreement defines when and where the predetermined shutdowns are to occur and defines how identifiers for those predetermined events are determined.

The second network function may, prior to said determining whether to cause the user equipment to be registered with the second network operator, signal first signalling that comprises the first identifier (e.g., to the user equipment).

In all of the above examples of FIGS. 7 to 9, the first signalling may comprise at least one of: an indication of when the predetermined event ends; an identification of the second network operator; an indication of at least one first preferred frequency band for discovering the second network operator; and/or an indication of at least one second preferred frequency band for discovering the first network operator after the predetermined event ends. The identifier of the second network operator may be at least one of: a physical call identifier; a new radio cell global identifier; a tracking area identifier; or a public land mobile network identifier.

In all of the above examples of FIGS. 7 to 9, the first network operator may comprise a home public land mobile network of the user equipment, and/or the second network operator may comprise a visited public land mobile network of the user equipment.

In all of the above examples of FIGS. 7 to 9, the predetermined event may be an energy efficiency event. The energy efficiency event may comprise a maintenance event. The energy efficiency event may comprise an event that is exclusively for saving energy.

The above examples of FIGS. 7 to 9 may be performed for national roaming events.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

As provided herein, various aspects are described in the detailed description of examples and in the claims. In general, some examples may be implemented in hardware or special purpose circuits, software, logic or any combination thereof. For example, some aspects may be implemented in hardware, while other aspects may be implemented in firmware or software which may be executed by a controller, microprocessor or other computing device, although examples are not limited thereto. While various examples may be illustrated and described as block diagrams, flow charts, or using some other pictorial representation, it is understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures, e.g., as in FIG. 7 and/or FIG. 8 and/or FIG. 9, and/or otherwise described previously, may represent program steps, or interconnected logic circuits, blocks and functions, or a combination of program steps and logic circuits, blocks and functions. The software may be stored on such physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term herein, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

1-39. (canceled)

40. An apparatus comprising: at least one processor; and at least one memory storing instructions that, when executed by the at least one processor, cause the apparatus at least to perform:
receiving, from at least one of a first network operator and a second network operator, first signalling comprising an indication that at least one first cell provided by the first network operator is or will be shutdown for a predetermined event, the first signalling comprising a first identifier that identifies the predetermined event; and
selecting the second network operator for receiving services via the second network operator based on the first signalling.

41. The apparatus of claim 40, wherein the selecting further comprises:
attempting to register with the second network operator for receiving said services via the second network operator by:
signalling a first registration request to the second network operator, the first registration request comprising the first identifier; and
receiving, from the second network operator, a response to the registration request.

42. The apparatus of claim 41, wherein the attempting to register is not performed successfully, and the method further comprises receiving, from the second network operator, an indication that the registration attempt has been unsuccessful.

43. The apparatus of claim 41, wherein the attempting to register is performed successfully, and the method further comprises receiving said services from the second network operator.

44. The apparatus of claim 43, wherein the apparatus is further caused to perform:
receiving, from at least one of the first and second network operators, an indication of when the predetermined event will end; and
based on an end of the predetermined event, deregistering with the second network operator for said services and registering with the first network operator for said services.

45. The apparatus of claim 44, wherein said deregistering is performed by signalling a deregistration request to the second network operator, the deregistration request comprising the first identifier.

46. The apparatus of claim 44, wherein said deregistering is performed by receiving, from the second network operator, an indication that the user equipment has been deregistered by the second network operator for receiving said services in the second network.

47. The apparatus of claim 44, wherein the apparatus is further caused to perform: abstaining from searching for the first network operator until at least the end of the predetermined event.

48. The apparatus of claim 41, wherein the apparatus is further caused to perform:
receiving, in the first signalling, an indication of a first time period during which the user equipment is to attempt to register with the second network operator; and
causing the attempt to register with the second network operator to be performed within said first time period.

49. The apparatus of claim 40, wherein the apparatus is further caused to perform: prior to said selecting, receiving said services from the first network operator.

50. The apparatus of claim 40, wherein the apparatus is further caused to perform:
prior to receiving said first signalling:
signalling, to the first network operator, an indication that the user equipment supports registering with the second network operator for receiving said services based on the first network operator performing predetermined shutdowns of at least one cell operated by the first network operator.

51. The apparatus of claim 40, wherein the apparatus is further caused to perform:
receiving, from at least one of the first and second network operators, an indication of at least one second preferred frequency band for discovering the first network operator after the predetermined event ends; and
based on an end of the predetermined event, discovering and attempting to register with the first network operator for said services using the at least one second preferred frequency band.

52. The apparatus of claim 40, wherein the apparatus is further caused to perform:
receiving, in the first signalling, at least one first preferred frequency band and/or an identifier of the second network operator for selecting the second network operator; and
using the identifier of the second network operator and/or the at least one first preferred frequency band for selecting the second network operator.

53. The apparatus of claim 40, wherein the selecting a second network operator comprises selecting at least one cell of the second network operator.

54. The apparatus of claim 52, wherein the identifier of the second network operator is at least one of: a physical call identifier; a new radio cell global identifier; a tracking area identifier; or a public land mobile network identifier.

55. The apparatus of claim 40, wherein the first signalling comprises at least one of:
an indication of when the predetermined event ends;
an identification of the second network operator;
an indication of at least one first preferred frequency band for discovering the second network operator; and/or
an indication of at least one second preferred frequency band for discovering the first network operator after the predetermined event ends.

56. The apparatus of claim 40, wherein the first network operator comprises a home public land mobile network of the user equipment, and/or the second network operator comprises a visited public land mobile network of the user equipment.

57. The apparatus of claim 40, wherein the predetermined event is an energy efficiency event.

58. An apparatus comprising: at least one processor; and at least one memory storing instructions that, when executed by the at least one processor, cause the apparatus at least to perform:
causing a user equipment to be registered for services via the first network operator based on receiving a first registration request from the user equipment, the first registration request comprising an indication that the user equipment supports registering with a second network operator for receiving said services after the first network operator performs predetermined shutdowns of at least one cell operated by the first network operator, the second network operator providing at least one second cell that at least partially overlaps with the at least one first cell;
causing said services to be provided to the user equipment;
determining that at least one first cell provided by the first network operator that provides said services to the user equipment will be shutdown for a predetermined event;
causing the user equipment to be signalled with first signalling comprising an indication that the least one first cell will be shutdown for a predetermined event, the first signalling further comprising a first identifier that identifies the predetermined event; and
causing said at least one first cell to be shutdown.

59. An apparatus comprising: at least one processor; and at least one memory storing instructions that, when executed by the at least one processor, cause the apparatus at least to perform:
determining whether to cause a user equipment to be registered with the second network operator based on receiving signalling comprising a first registration request from the user equipment, the first registration request comprising a first identifier, the first identifier identifying a predetermined event in which at least one first cell provided by a first network operator is shutdown for the duration of a predetermined event; and
signalling a result of said determining to the user equipment.
